(19) United States
(12) Patent Application Publication
(10) Pub. No.: US 2005/0231886 A1
(43) Pub. Date: Oct. 20, 2005

(54) Substrate attaching device and method

(75) Inventors: Ching-Wei Chiang, Miao-Li (TW); Yen-Chung Chiang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/097,439

(22) Filed: Mar. 31, 2005

(30) Foreign Application Priority Data
Apr. 16, 2004 (TW) 93110618

(51) Int. Cl. H01H 1/00; H02B 1/00

(52) U.S. Cl. 361/234

(57) ABSTRACT

A substrate attaching device (3) includes a vacuum chamber (31), a first electrostatic chuck (32) set in the vacuum chamber, a working table (33) set below the first electrostatic chuck, a gas supply (34), a first controller (36) used to control the gas supply, and a second controller (37) used to control evacuation of the vacuum chamber. The first electrostatic chuck includes a chuck body (321) with a plurality of gas releasing holes (322). A method for attaching two substrates includes: holding a first substrate and a second substrate to the first electrostatic chuck and on the working table, respectively; moving the first electrostatic chuck and the working table closer together until they are attached together; and supplying a gas to separate the first substrate from the first electrostatic chuck, and evacuating the vacuum chamber at the same time.

### BACKGROUND OF THE INVENTION

1. Field of the Invention

The present invention relates to a substrate attaching device and a substrate attaching method, and especially to a device used for combining two substrates such as those that form the framework of a liquid crystal display (LCD) cell.

2. Description of Prior Art

An LCD cell generally comprises two glass substrates, a peripheral sealant, and a plurality of liquid crystal molecules retained between the substrates. The sealant is printed on one of the glass substrates, and is adhered to the other glass substrate. The substrates and the sealant cooperatively form a space therebetween, with the liquid crystal molecules being filled in the space.

There are generally two methods used for filling the liquid crystal molecules into the space. The first method is to fill the liquid crystal molecules through filling ports. This method comprises the following steps: firstly, printing a sealant on a first glass substrate, wherein the sealant is rectangular and has one or more gaps that function as filling ports; secondly, combining a second glass substrate with the first glass substrate and curing the sealant, wherein a space is enclosed by the sealant and the two glass substrates; thirdly, immersing the filling ports in a liquid crystal in a vacuum chamber; and finally, introducing gas into the vacuum chamber to make the liquid crystal molecules fill up the space.

The second method is the so-called one-drop-fill (ODF) method. This method comprises the following steps: firstly, printing a sealant on a first glass substrate, wherein the sealant is rectangular and continuous, and a space is enclosed by the sealant and the first glass substrate; secondly, putting liquid crystal molecules into the space drop by drop using a dispenser; and finally, combining a second glass substrate with the first glass substrate and curing the sealant. The ODF process also needs to be performed in a vacuum when the substrates are combined. Thus, a substrate attaching device that can provide a vacuum is used.

A conventional substrate attaching device as disclosed in Taiwan Patent No. 526,367 utilizes an electrostatic chuck (ESC) to attach a first substrate thereto, and then to attach the first substrate to a second substrate placed on a working table. The ESC attracts the first substrate by electrostatic attraction produced by a voltage applied on the ESC. After the first substrate is attached to the second substrate, the voltage applied on the ESC is stopped, so that the ESC does not attract the first substrate. However, because charges accumulated on the ESC do not dissipate instantly, the electrostatic attraction of the first substrate also does not stop instantly.

Referring to FIG. 3, this shows another conventional substrate attaching device 1. The substrate attaching device 1 comprises a vacuum chamber 11, a first ESC 12, a working table 13, a gas supply 14, and a controller 15. The first ESC 12 and the working table 13 are set in the vacuum chamber 11. The first ESC 12 comprises a chuck body 121 with a plurality of gas releasing holes 122. The gas releasing holes 122 communicate with a gas pipe 141 used to transfer nitrogen gas from the gas supply 14 to the bottom surface of the chuck body 121. The vacuum chamber 11 has a vacuum pump (not shown) used to evacuate the inside of the vacuum chamber 11 to a pressure of about 0.1 torr. The controller 15 controls the gas supply 14 and the vacuum pump to operate at different times to feed nitrogen gas or evacuate the inside of the vacuum chamber alternately.

A substrate attaching method using the substrate attaching device 1 comprises following steps. Firstly, a second substrate 23 with a printed sealant 231 is placed on the working table 13. Liquid crystal 232 is dropped onto the second substrate 23 within the sealant 231. Secondly, a first substrate 22 is attached to the chuck body 121. Thirdly, the first substrate 22 and the second substrate 23 are aligned with each other, and the first ESC 12 is lowered to attach the first substrate 22 on the second substrate 23. Finally, referring to FIG. 4, operation of the vacuum pump is stopped by the controller 15, and nitrogen gas is supplied at high pressure to the bottom surface of the chuck body 121 by the gas supply 14 under the control of the controller 15. The flowing nitrogen gas can help separate the first substrate 22 from the chuck body 121, so that the combined first and second substrates 22, 23 can be removed from the working table 13.

However, when the gas supply 14 supplies nitrogen gas to the chuck body 121, the vacuum pump of the vacuum chamber stops working. Thus, the pressure in the space between the two attached substrates 22, 23 is lower than the pressure in the vacuum chamber 11. The nitrogen gas can seep into the space enclosed by the attached substrates 22, 23 and the sealant 231. When this happens, the nitrogen gas may even cause bubbles to form in the liquid crystal 232. These can result in impaired performance or even failure of the LCD cell.

Thus, a new substrate attaching device and a new substrate attaching method which overcome the above-mentioned disadvantages are desired.

### SUMMARY OF THE INVENTION

An object of the present invention is to provide a substrate attaching device that can improve the yield of mass-manufactured LCD cells.

Another object of the present invention is to provide a substrate attaching method that can improve the yield of mass-manufactured LCD cells.

In order to achieve the first object set out above, a substrate attaching device comprises a vacuum chamber, a first electrostatic chuck set in the vacuum chamber, a working table set below the first electrostatic chuck when the substrate attaching device is used to attach substrates, a gas supply, a first controller used to control the gas supply, and a second controller used to control evacuation of the vacuum chamber. The first electrostatic chuck comprises a chuck body with a plurality of gas releasing holes. The gas supply communicates with the gas releasing holes through a gas pipe.

In order to achieve the second object set out above, a method for reliably attaching two substrates together comprises: providing a substrate attaching device with a first electrostatic chuck and a working table set below the first electrostatic chuck, the first electrostatic chuck and the working table being set in a vacuum chamber; holding a first one of the substrates and a second one of the substrates to the first electrostatic chuck and on the working table, respectively; moving the first electrostatic chuck and the working table closer together until the first substrate and the second substrate are attached together; and supplying a gas to separate the first substrate from the first electrostatic chuck, and evacuating the vacuum chamber at the same time.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a schematic, side cross-sectional view of a substrate attaching device according to the present invention;

FIG. 2 is a schematic, side cross-sectional view showing a step of a method of the present invention for attaching two substrates together, the method being performed using the substrate attaching device of FIG. 1;

FIG. 3 is a schematic, side cross-sectional view of a conventional substrate attaching device; and

FIG. 4 is a similar to FIG. 3, but showing a step of a conventional method for attaching two substrates together, using the substrate attaching device illustrated.

### DETAILED DESCRIPTION OF THE INVENTION

Reference will now be made to the drawings to describe the present invention in detail.

Referring to FIG. 1, a substrate attaching device 3 in accordance with the present invention comprises a vacuum chamber 31, a first ESC 32, a working table 33, a gas supply 34, a first controller 36, and a second controller 37.

The vacuum chamber 31 has a vacuum pump (not shown) used to evacuate the inside of the vacuum chamber 31 to a pressure of about 0.1 torr. Thus, the vacuum chamber 31 can provide a vacuum environment. The vacuum pump is individually controlled by the second controller 37.

The first ESC 32 is set in the vacuum chamber 31, and comprises a chuck body 321 with a plurality of gas releasing holes 322. The chuck body 321 can attach a first substrate 42 thereto by electrostatic attraction. The first ESC 32 can be raised or lowered relative to the working table 33. The working table 33 is used to support a second substrate 43 thereon. After the second substrate 43 is placed on the working table 33, the working table 33 is moved into the vacuum chamber 31 and is located under the first ESC 32. That is, the working table 33 can be moved into and out from the vacuum chamber 31.

The gas releasing holes 322 communicate with the gas supply 34 through a gas pipe 341, which transfers nitrogen gas from the gas supply 34 to the bottom surface of the chuck body 321. The first controller 36 individually controls the gas supply 34 to feed nitrogen gas as required.

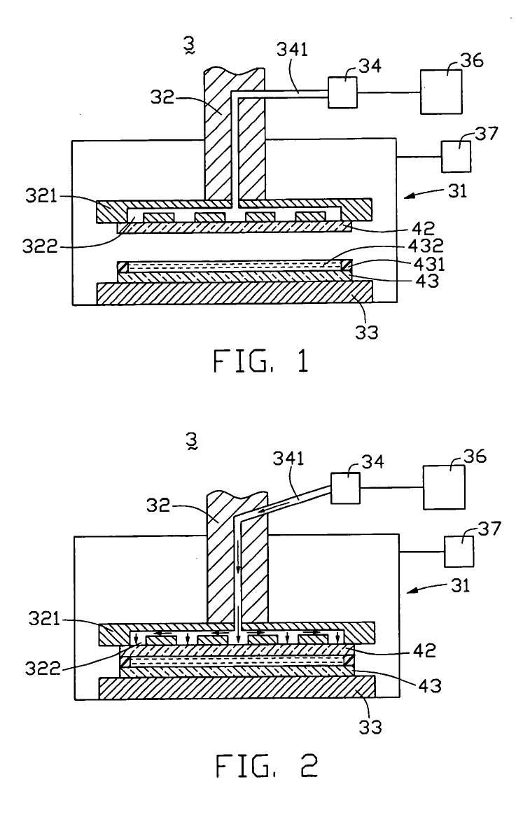

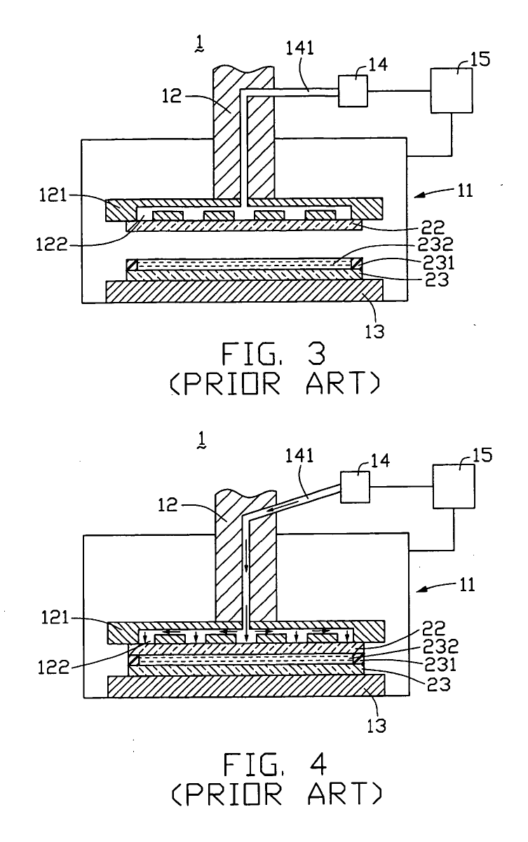

A substrate attaching method using the substrate attaching device 3 comprises the following steps. Firstly, the working table 33 is moved out of the vacuum chamber 31, and the second substrate 43 is placed on the working table 33. Secondly, a sealant 431 is printed on the second substrate 43, and liquid crystal molecules are put into a space enclosed by the sealant 431 and the second substrate 43 drop by drop using a dispenser (not shown). Thirdly, the first substrate 42 is attached to the chuck body 321 by electrostatic attraction. Fourthly, the first substrate 42 and the second substrate 43 are aligned with each other, and the first ESC 32 is lowered to attach the first substrate 42 on the second substrate 43. Finally, referring to FIG. 2, the vacuum pump is activated under the control of the second controller 37, and nitrogen gas is supplied at high pressure to the bottom surface of the chuck body 321 by the gas supply 34 under the control of the first controller 36 at the same time. The flowing nitrogen gas can help to separate the first substrate 42 from the chuck body 321.

The gas supply 34 and the vacuum pump of the vacuum chamber 31 are respectively controlled by the first controller 36 and the second controller 37. When the gas supply 34 feeds nitrogen gas into the vacuum chamber 31, the vacuum pump continues to evacuate the inside of the vacuum chamber 31. Thus, the pressure inside the attached substrates 42, 43 is equal to the pressure of the vacuum chamber 31, and the nitrogen gas cannot seep into the space enclosed by the attached substrates 42, 43 and the sealant 431. The yield of LCD cells manufactured using the method is improved.

In an alternative embodiment, the working table 33 can instead be a chuck body, to which the second substrate 43 is attached by electrostatic attraction.

It is to be further understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A substrate attaching device, comprising:
a vacuum chamber;
a first electrostatic chuck set in the vacuum chamber, and comprising a chuck body with a plurality of gas releasing holes;
a working table set below the first electrostatic chuck when the substrate attaching device is used to attach substrates;
a gas supply communicating with the gas releasing holes through a gas pipe;
a first controller used to control the gas supply; and
a second controller used to control evacuation of the vacuum chamber.

2. The substrate attaching device as recited in claim 1, wherein the working table is an electrostatic chuck comprising a chuck body.

3. The substrate attaching device as recited in claim 1, wherein the gas supply supplies nitrogen gas.

4. The substrate attaching device as recited in claim 1, wherein the working table can be moved into and out from the vacuum chamber.

5. The substrate attaching device as recited in claim 1, wherein the vacuum chamber further comprises a vacuum pump used to evacuate the inside of the vacuum chamber, and the vacuum pump is controlled by the second controller.

6. A method for reliably attaching two substrates together, comprising:
providing a substrate attaching device with a first electrostatic chuck and a working table set below the first electrostatic chuck, the first electrostatic chuck and the working table being set in a vacuum chamber;
holding a first one of the substrates and a second one of the substrates to the first electrostatic chuck and on the working table, respectively;
moving the first electrostatic chuck and the working table closer together until the first substrate and the second substrate are attached together; and
supplying a gas to separate the first substrate from the first electrostatic chuck, and evacuating the vacuum chamber at the same time.

7. The method as recited in claim 6, wherein the working table is an electrostatic chuck comprising a chuck body.

8. The method as recited in claim 6, wherein the gas is nitrogen gas.

9. The method as recited in claim 6, wherein the first electrostatic chuck comprises a chuck body with a plurality of gas releasing holes.

10. The method as recited in claim 9, wherein the gas is supplied by a gas supply, which communicates with the gas releasing holes through a gas pipe.

11. The method as recited in claim 10, wherein the gas supply is controlled by a first controller.

12. The method as recited in claim 6, wherein the vacuum chamber comprises a vacuum pump, and evacuation of the vacuum chamber is performed by the vacuum pump.

13. The method as recited in claim 12, wherein the vacuum pump is controlled by a second controller.

14. The method as recited in claim 6, further comprising the steps of: printing a sealant on the second substrate, and releasing liquid crystal into a space enclosed by the sealant and the second substrate.

15. A method for reliably attaching two substrates together, comprising:
providing a vacuum chamber;
having holding device hold a first substrate;
adhering said first substrate to a second substrate in said vacuum chamber during a vacuum operation; and
supplying a gas to separate the first substrate from the holding device before termination of said vacuum operation.
